(19) United States
(12) Patent Application Publication
(10) Pub. No.: US 2024/0308055 A1
(43) Pub. Date: Sep. 19, 2024

(54) TRUSS ASSEMBLY TABLE WITH TRUSS EJECTION MECHANISMS

(71) Applicant: Illinois Tool Works Inc., Glenview, IL (US)

(72) Inventors: Mathew Nickolas Milton, Carrollton, TX (US); Ronald E. Findley, Arlington, TX (US); Steven E. Daniels, Georgetown, TX (US); Heather M. Veach, Waco, TX (US); John L. Carmical, Hewitt, TX (US); Caleb Scarbrough, Waco, TX (US)

(21) Appl. No.: 18/596,101

(22) Filed: Mar. 5, 2024

Related U.S. Application Data
(60) Provisional application No. 63/490,583, filed on Mar. 16, 2023.

(51) Int. Cl. B25H 1/02; B25B 11/02

(52) U.S. Cl. CPC B25H 1/02; B25B 11/02

(57) ABSTRACT

A truss assembly table having a plurality of truss ejection mechanisms configured to eject assembled trusses from the truss assembly table.

### PRIORITY CLAIM

This application claims priority to and the benefit of U.S. Provisional Patent Application Ser. No. 63/490,583, filed Mar. 16, 2023, the entire contents of which are incorporated herein by reference.

### BACKGROUND

Wooden trusses are widely used throughout the construction industry. Wooden trusses are often constructed from conventional dimensional lumber members (such as what is commonly known as: a 2 by 4; a 2 by 6; a 2 by 8; etc.). The wooden members that are used to construct a wooden truss are sometimes called truss members in general with the most common truss member types sometimes called chord members and web members. Such chord members often extend longitudinally along the length of the truss and such web members often extend transversely to the length of the truss such as along the width of the truss. A wooden truss is often built from numerous wooden truss members and metal connectors. The metal connectors are used to attach the truss members to build the wooden truss. Wooden trusses are often prefabricated in a factory and then shipped to a construction site where the wooden trusses are used to construct part of the structure of a building (such as a house or commercial facility). Buildings constructed with such prefabricated wooden roof trusses are often more economical and faster to construct than buildings constructed with conventional stick framed structures.

Various truss assembly tables have been developed. Various known truss assembly tables are used for manufacturing floor trusses that are employed to form a floor supporting structure. One issue with various known truss assembly tables is that they have complicated mechanisms for ejecting built trusses from the truss assembly table. Accordingly, there is a need for improved truss assembly tables that address this issue.

### SUMMARY

The present disclosure provides a truss assembly table with ejection mechanisms that overcomes the above described issue. In various embodiments, the truss assembly table is configured to enable trusses to be simultaneously built on the table, and that includes truss ejection mechanisms configured to eject the built trusses from the truss assembly table.

Additional features and advantages of the present disclosure are described in, and will be apparent from, the following Detailed Description and the Figures.

### BRIEF DESCRIPTION OF THE FIGURES

FIG. 1 is a top perspective or isometric view of a known truss assembly table.

FIG. 2 is a fragmentary top perspective or isometric section view of a truss assembly table including ejection mechanisms in accordance with one example embodiment of the present disclosure, and showing a part of a truss positioned on a first side of the truss assembly table.

FIG. 3 is an enlarged fragmentary end view of the truss assembly table of FIG. 2 showing parts of one of the ejection mechanisms of the truss assembly table in a retracted position.

FIG. 4 is an enlarged fragmentary end view of the truss assembly table of FIG. 2 showing parts of one of the ejection mechanisms of the truss assembly table in an extended position.

FIG. 5 is an enlarged fragmentary end view of the truss assembly table of FIG. 2 showing parts of one of the ejection mechanisms of the truss assembly table in an extended position.

FIG. 6 is an enlarged fragmentary top perspective view of part of the truss assembly table of another example embodiment of the present disclosure showing parts of an alternative ejection mechanism.

### DETAILED DESCRIPTION OF EXAMPLE EMBODIMENTS

While the systems, devices, and methods described herein may be embodied in various forms, the drawings show, and the specification describes certain exemplary and non-limiting embodiments. Not all components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

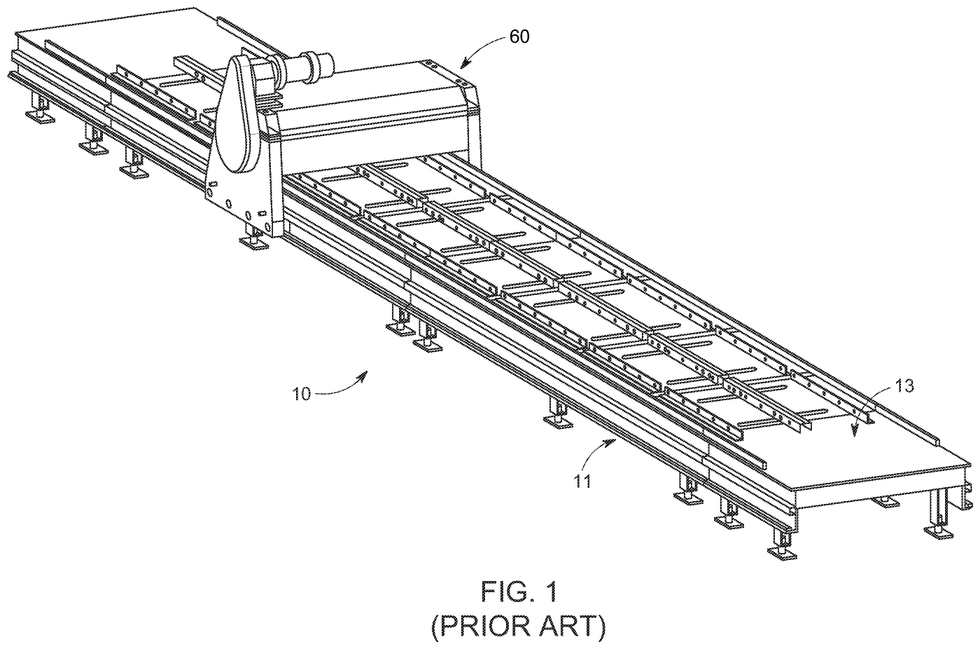

FIG. 1 shows a known truss assembly table 10. This known truss assembly table 10 generally includes: (a) a table frame 11; (2) a tabletop 13; and (3) a movable gantry 60. This known truss assembly table 10 is also configured for simultaneously forming two or more floor trusses on the truss assembly table 10 on each side in and end-to-end manner on the tabletop 13.

The present disclosure relates to improvements to known truss assembly tables (such as the truss assembly table shown in FIG. 1), and particularly provides a truss assembly table with multiple ejection mechanisms configured to eject built trusses from the truss assembly table. The ejection mechanisms apply uniform ejections forces to the built trusses to reduce the likelihood that the built truss will be damaged during the ejection process. The ejection mechanisms are also less complicated than known ejection mechanisms. Example embodiments of the truss assembly table and ejection mechanisms of the present disclosure are discussed below; however, it should be appreciated that the present disclosure is not limited to the illustrated example truss assembly tables or ejection mechanisms. For brevity, various components of the truss assembly table of the present disclosure are not described herein because such components are well known in the industry.

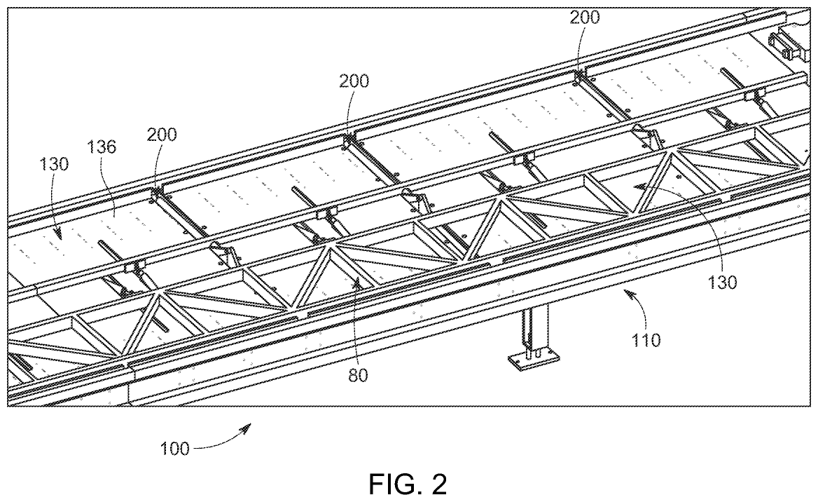

FIGS. 2, 3, 4, and 5 illustrate one example embodiment of a truss assembly table. This truss assembly table is indicated by numeral 100. The example illustrated truss assembly table 100 generally includes: (1) a table frame 110; (2) a tabletop 130; (3) a plurality of spaced-apart ejection mechanisms 200; (4) a gantry (not shown); (5) a controller (not shown); (6) an operator interface (not shown); and (7) a power supply (not shown).

More specifically, the table frame 110 includes a plurality of frame components (not individually labeled) that are configured and attached in a suitable manner to support the other components of the truss assembly table 100. These frame components can take any suitable shape, can be formed is any suitable manner, and can be formed from any suitable materials. The table frame 110 has a longitudinal length that is longer than any truss to be built on the truss assembly table 100. The table frame 110 has a transverse width that is more than twice the width of any truss to be built on the truss assembly table 100, so as to enable two or more trusses to be built on the truss assembly table 100.

The tabletop 130 is supported by the table frame 110, has a longitudinal length that is longer than any truss to be built on the truss assembly table 100, and has a transverse width that is more than twice the width of any truss to be built on the truss assembly table 100, so as to enable two or more trusses to be built on the truss assembly table 100. The tabletop 130 includes one or more horizontally extending members (not labeled), wherein the upper most member includes an upper build surface 136 on which trusses being built on the truss assembly table 100 can rest. The tabletop 130 can be formed is any suitable manner and can be formed from any suitable materials.

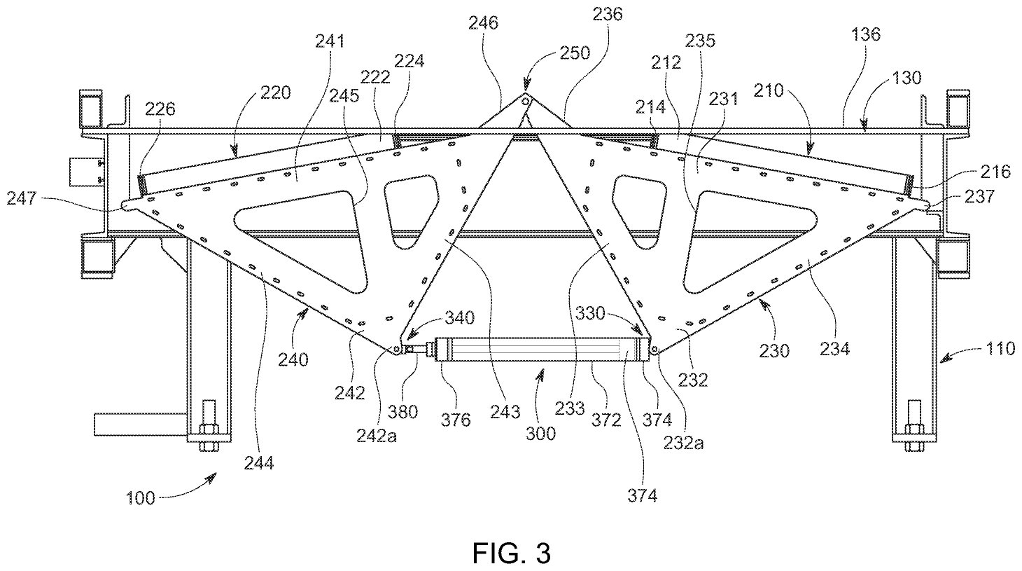

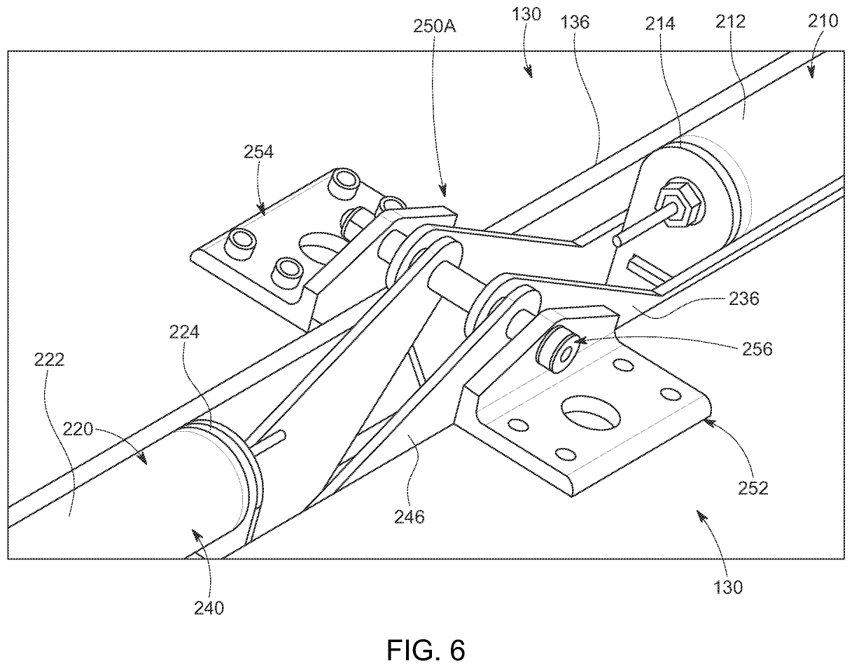

The multiple evenly spaced-apart truss ejection mechanisms 200 are all identical in this example embodiment, and thus for brevity, only one of the truss ejection mechanisms 200 is described herein in detail. As best shown in FIGS. 3, 4, and 5, the truss ejection mechanism 200 includes: (1) a first truss ejector 210; (b) a second truss ejector 220; (3) a first ejection bracket 230; (4) a second ejection bracket 240; (3) a hinge assembly 250; and (4) an actuator 300. FIG. 6 shows example alternative configurations of certain of these components in accordance with the present disclosure and as further discussed below.

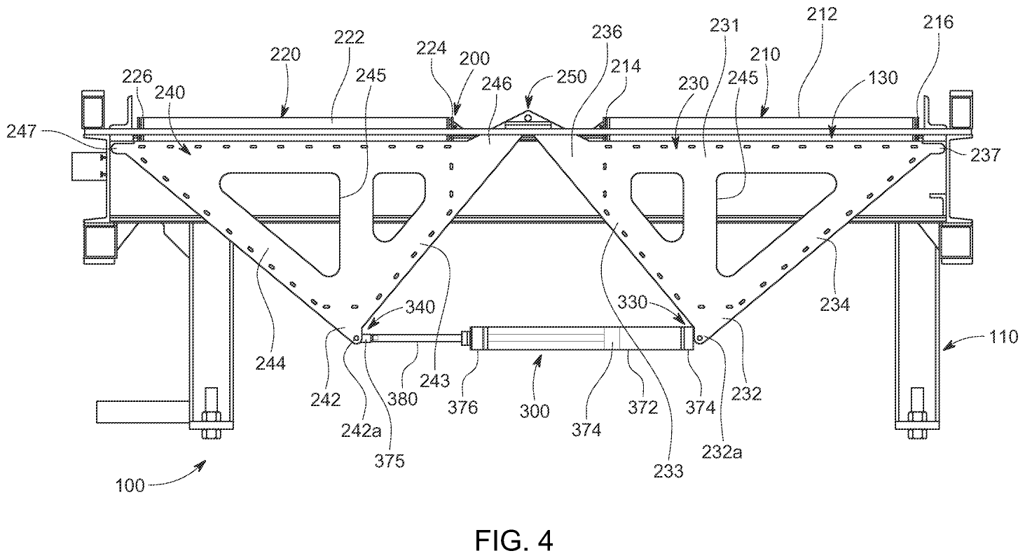

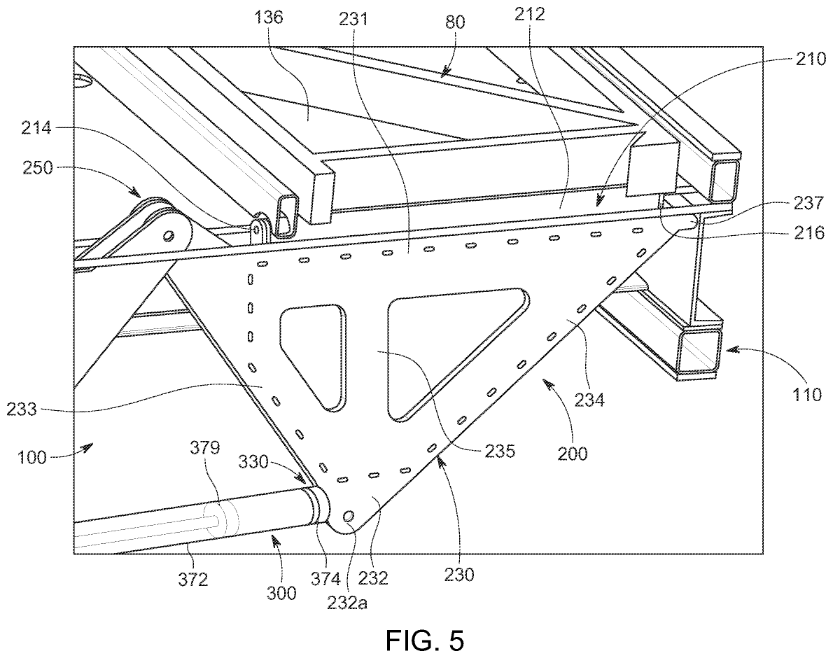

The first truss ejector 210 includes a driven rotatable roller 212 rotatably supported at opposite ends by roller supports 214 and 216 that are connected to and that extend upwardly from the first ejection bracket 230. The first truss ejector 210 includes a suitable first roller actuator (not shown) such as a motor (not shown) controlled by the controller and configured to rotate the roller 212 as further discussed below. The rotatable roller 212 extends transversely to the tabletop 130. The first truss ejector 210 is configured to be moved and particularly pivoted upwardly through a transversely extending opening in the tabletop 130 from a retracted position below the tabletop 130 (such as shown in FIG. 3) to an extended position at least partially above the tabletop 130 (such as shown in FIGS. 4 and 5). In the extended position, the roller 212 of the first truss ejector 210 is configured to vertically lift and longitudinally move a truss positioned on the first side of the truss assembly table 100 as further described below.

Likewise, the second truss ejector 220 includes a driven rotatable roller 222 rotatably supported at opposite ends by roller supports 224 and 226 that are connected to and that extend upwardly from the second ejection bracket 240. The second truss ejector 220 includes a suitable second roller actuator (not shown) such as a motor (not shown) controlled by the controller and configured to rotate the roller 222 as further discussed below. The rotatable roller 222 extends transversely to the tabletop 130. The second truss ejector 220 is configured to be moved and particularly pivoted upwardly through the transversely extending opening in the tabletop 130 from a retracted position below the tabletop 130 (such as shown in FIG. 3) to an extended position at least partially above the tabletop 130 (such as shown in FIGS. 4 and 5). In the extended position, the roller 222 of the second truss ejector 220 is configured to vertically lift and longitudinally move a truss positioned on the second side of the truss assembly table 100 as further described below.

The first ejection bracket 230 has a generally triangular shape and includes: (1) a transversely extending upper section 231; (2) a lower section 232; (3) an inner angled section 233 connected to and extending downwardly from an inner end portion (not labeled) of the upper section 231 to the lower section 232; (4) an outer angled section 234 connected to and extending downwardly from an outer end portion (not labeled) of the upper section 231 to the lower section 232; (5) a brace 235 connected to and extending between the upper section 231 and the lower section 232; and (6) a hinge arm 236 extending upwardly and inwardly from the upper section 231. The lower section 232 is substantially narrower (i.e., has a smaller transverse width) than the upper section 231. In this example embodiment, the first ejection bracket 230 is formed from two spaced-apart connected panels (not labeled), although the first ejection bracket 230 can be otherwise formed. In this example embodiment, the first ejection bracket 230 includes an outwardly extending support finger 237 configured to rest on a part of the frame 110 (such as an inwardly extending first lip (shown in FIGS. 3 and 4 but not labeled) of the frame 110 to support the first ejection bracket 230 when the first ejection bracket 230 is in the lower position such as shown in FIG. 3. The outwardly extending support finger 237 is also configured to engage a part (not labeled) of the frame 110 to limit the upward movement of the first ejection bracket 230 as shown in FIGS. 4 and 5.

The first ejection bracket 230 is configured to be moved and particularly pivot upwardly from a lower position (such as shown in FIG. 3) to an upper position (such as shown in FIGS. 4 and 5). The first ejection bracket 230 pivots upwardly and downwardly about via the hinge assembly 250 and the actuator 300. The first ejection bracket 230 and particularly the upper section 231 of the first ejection bracket 230 supports the first ejector 210, and is configured to move the first ejector 210 between the retracted position and extended positions.

Likewise, the second ejection bracket 240 has a generally triangular shape and includes: (1) a transversely extending upper section 241; (2) a lower section 242; (3) an inner angled section 243 connected to and extending downwardly from an inner end portion (not labeled) of the upper section 241 to the lower section 242; (4) an outer angled section 244 connected to and extending downwardly from an outer end portion (not labeled) of the upper section 241 to the lower section 242; (5) a brace 245 connected to and extending between the upper section 241 and the lower section 242; and (6) a hinge arm 246 extending upwardly and inwardly from the upper section 241. The lower section 242 is substantially narrower (i.e., has a smaller transverse width) than the upper section 241. In this example embodiment, the second ejection bracket 240 is formed from two spaced-apart connected panels (not labeled), although the second ejection bracket 240 can be otherwise formed. In this example embodiment, the second ejection bracket 240 includes an outwardly extending support finger 247 configured to rest on a part (not shown) of the frame 110 to support the second ejection bracket 240 when the second ejection bracket 240 is in the lower position if needed. The outwardly extending support finger 247 is also configured to engage a part (not labeled) of the frame 110 to limit the upward movement of the second ejection bracket 240 as shown in FIGS. 4 and 5.

The second ejection bracket 240 is configured to be moved and particularly pivot upwardly from a lower position (such as shown in FIG. 3) to an upper position (such as shown in FIGS. 4 and 5). The second ejection bracket 240 pivots upwardly and downwardly about via the hinge assembly 250 and the actuator 300. The second ejection bracket 240 and particularly the upper section 241 of the second ejection bracket 240 supports the second ejector 220, and is configured to move the second ejector 220 between the retracted position and extended positions.

The hinge assembly 250 pivotally connects the first ejection bracket 230 to the second ejection bracket 240 and particularly pivotally connects the hinge arm 236 of the first ejection bracket 230 to the hinge arm 246 of the second ejection bracket 240. The hinge assembly 250 includes a longitudinally extending pivot pin (not shown or labeled in FIGS. 3, 4, or 5) that connects the hinge arm 236 to the hinge arm 246. The hinge assembly is above the upper build surface 136 of the tabletop 130. The pivot pin and thus the pivot axis of the hinge assembly is above the tabletop 130. The hinge assembly 250 can be any suitable hinge assembly and can include any suitable pivot pin. One further example hinge assembly 250A is shown in FIG. 6. This example hinge assembly 250A includes two L-shaped brackets 252 and 254 positioned on and fixedly connected to the upper build surface 136 of the tabletop 130 by suitable fasteners (not labeled) on opposite sides of the transversely extending opening (not labeled) in the tabletop 130. The hinge assembly 250A further includes a pivot pin 256 supported by and extending through the two L-shaped brackets 252 and 254 and extending through the respective the hinge arms 236 and 246 of the first and second ejection brackets 230 and 240. The example hinge assembly 250A enables the hinge arms 236 and 246 and thus the first and second ejection brackets 230 and 240 to pivot upwardly and downwardly with respect to each other.

The actuator 300 includes a first end 330 and an opposite second end 340. The first end 330 of the actuator 300 is pivotally connected to the lower section 232 of the first ejection bracket 230. The second end 340 of the actuator 300 is pivotally connected to the lower section 242 of the second ejection bracket 240. The actuator 300 extends between the lower section 232 of the first ejection bracket 230 and the lower section 242 of the second ejection bracket 240. More specifically, in the example embodiment of FIGS. 3, 4, and 5, the actuator 300 includes a pneumatically powered cylinder controlled by the controller (such as via an air compressor (not shown) controlled by the controller). More specifically the actuator 300 includes: (a) a cylinder bore end 372; (b) a first cylinder bore end clevis 374 attached to a first end of the cylinder bore end 372 and pivotally connected to a connection member 232a of the lower section 232 of the first ejection bracket 230 by a pivot pin (not shown or labeled); (c) a second cylinder bore end 376 attached to a second end of the cylinder bore end 372; (d) a movable piston (not shown) in the cylinder bore end 372; (e) a movable piston rod 380 having a first end attached to the piston and a second end clevis 375 attached by a pivot pin (not labeled) to a connection member 242a of the lower section 242 of the second ejection bracket 240; and (f) one or more air inlet/outlet ports (not shown). The actuator 370 is pneumatically powered in this example embodiment. However, it should be appreciated that the actuator could be powered in other suitable manners in accordance with the present disclosure. For example, the actuator can be formed from a suitably electrically powered solenoid.

The actuator 300 is configured to simultaneously move both the first ejection bracket 230 and the second ejection bracket 240. More specifically, the actuator 300 has a non-actuated configuration shown in FIG. 3 and an actuated configuration shown in FIGS. 4 and 5. In the non-actuated configuration, the actuator 300 causes the first and second ejection brackets 230 and 240 to be in their respective lower positions and also causes the first and second ejectors 210 and 220 to be in their respective retracted positions as shown in FIG. 3. In the actuated configuration, the actuator 300 moves the first and second ejection brackets 230 and 240 to be in their respective upper positions and also causes the first and second ejectors 210 and 220 to be in their respective extended positions as shown in FIGS. 4 and 5. Thus, in this example embodiment, the single actuator 300 is configured to simultaneously move both the first and second ejectors 210 and 220 from their retracted positions to their extended positions to engage and eject trusses on both the first and second sides of the truss assembly table 100.

The gantry includes any suitable gantry that is longitudinally moveable relative to the tabletop 130 and configured to secure attachment plates to the chord members and web members in a conventional manner or in a manner to be developed in the future.

In various embodiments, the controller includes a suitable switching mechanism that is manually controlled.

In various other embodiments, the controller can be a PLC board or integrated into a PLC board.

In various other embodiments, the controller includes a processing device (or devices) communicatively connected to a memory device (or devices). For instance, the controller can be a programmable logic controller.

The processing device can include any suitable processing device such as, but not limited to, a general-purpose processor, a special-purpose processor, a digital-signal processor, one or more microprocessors, one or more microprocessors in association with a digital-signal processor core, one or more application-specific integrated circuits, one or more field-programmable gate array circuits, one or more integrated circuits, and/or a state machine.

The memory device can include any suitable memory device such as, but not limited to, read-only memory, random-access memory, one or more digital registers, cache memory, one or more semiconductor memory devices, magnetic media such as integrated hard disks and/or removable memory, magneto-optical media, and/or optical media. The memory device stores instructions executable by the processing device to control operation of the truss assembly table 100.

The controller is communicatively and operably connected to the actuators, the operator interface, and the power supply, and configured to receive signals from and send signals to those components. The controller can also be communicatively connectable (such as via Wi-Fi, Bluetooth, near-field communication, or other suitable wireless communications protocol) to an external device, such as a computing device, to send information to and receive information from that external device. The controller can be configured to control a compressor that supplies compressed air to the actuator 300.

The operator interface can include a suitable display screen with a touch panel. In such embodiments with a display screen, the display screen is configured to display information regarding the truss assembly table 100, and the touch screen is configured to receive operator inputs. The operator interface is communicatively connected to the controller to send signals to the controller and to receive signals from the controller. Other embodiments of the truss assembly table 100 do not include a touch panel. Still other embodiments of the truss assembly table 100 do not include a display assembly. Certain embodiments of the truss assembly table 100 include a separate pushbutton panel instead of a touch panel beneath or integrated with the display screen. In certain embodiments of the truss assembly table 100, the operator interface includes one or more pushbuttons (and associated light) and no display screen or touch panel.

In various embodiments, the power supply is electrically connected to (via suitable wiring and other components) and configured to power several components of the truss assembly table 100. In various embodiments, the power supply can include a pneumatic air power supply.

In operation, the controller individually and jointly controls the operation of the truss ejection mechanisms 200 of the truss assembly table.

In operation, before trusses are built on both sides of the truss assembly table 100, the controller causes the actuator 300 of each of the truss ejections mechanisms 200 to be in the non-actuated configuration (FIG. 3) that in turn causes the first and second ejection brackets 230 and 240 of each of the truss ejections mechanisms 200 to be in their respective lower positions and also causes the first and second ejectors 210 and 220 of each of the truss ejections mechanisms 200 to be in their respective retracted positions. In these positions, the first and second ejectors 210 of each of the truss ejections mechanisms 200 are at least partially below the upper build surface 136 of the tabletop 130 and do not interfere with the building of the trusses on the first and second sides of the truss assembly table 100.

After the trusses are built on the first and second sides of the truss assembly table 100 (including after the use of the gantry to secure the attachment connectors to the cord members and the web members of the respective trusses), the controller can cause the actuator 300 of each of the truss ejections mechanisms 200 to simultaneously move to the actuated configuration such the length of the actuator 300 of each of the truss ejections mechanisms 200 increases—to cause both of the first and second ejection brackets 230 and 240 of each of the truss ejections mechanisms 200 to simultaneously pivot to their respective upper positions. This simultaneously upward pivoting of the first and second ejection brackets 230 and 240 of each of the truss ejections mechanisms 200 causes the first and second ejectors 210 and 220 of each of the truss ejections mechanisms 200 to move upwardly toward their respective extended positions to simultaneously push the built trusses upwardly on both sides of the truss assembly table 100 above the upper build surface 136 of the tabletop 130. The controller can then simultaneously activate the actuators that drive the ejection rollers 212 and 222 to cause the respective ejection rollers 212 and 222 of the truss ejections mechanisms 200 to rotate to longitudinally move the now lifted built trusses that are supported by the ejection rollers 212 and 222 off of the truss assembly table 100. After the built trusses are moved off of the truss assembly table 100, the controller can de-actuate the actuator 300 of each of the truss ejections mechanisms 200—to cause the first and second ejection brackets 230 and 240 of each of the truss ejections mechanisms 200 to return to their respective lower positions and also causes the first and second ejectors 210 and 220 of each of the truss ejections mechanisms 200 to return to their respective retracted positions.

It should be appreciated from the above that various embodiments of the present disclosure provide a truss assembly table including: a table frame; a tabletop connected to the table frame; and a plurality of spaced-apart ejection mechanisms supported by at least one of the table frame and the tabletop, each ejection member including: a first ejection bracket, a second ejection bracket, a first truss ejector connected to the first ejection bracket, a second truss ejector connected to the second ejection bracket, a hinge assembly pivotally connecting the first and second ejection brackets, and an actuator connected to the first and second ejection brackets, the actuator configured to simultaneously move the first and second ejection brackets from lower positions to upper positions to simultaneously move the first and second truss ejectors from retracted positions to extended positions. In various such embodiments, the first truss ejector includes a driven first rotatable roller supported at opposite ends by roller supports connected to and extending upwardly from the first ejection bracket, and the second truss ejector includes a driven second rotatable roller supported at opposite ends by roller supports connected to and extending upwardly from the second ejection bracket. In various such embodiments, the first ejection bracket has an upper section and a lower section, wherein the lower section is narrower than the upper section, and wherein the second ejection bracket has an upper section and a lower section, wherein the lower section is narrower than the upper section. In various such embodiments, the actuator is pivotally connected to the lower section of the first ejection bracket and pivotally connected to the lower section of the second ejection bracket. In various such embodiments, the actuator extends between the lower section of the first ejection bracket and the lower section of the second ejection bracket. In various such embodiments, the hinge assembly pivotally connects the upper section of the first ejection bracket to the upper section of the second ejection bracket. In various such embodiments, the hinge assembly is mounted on the tabletop. In various such embodiments, the hinge assembly includes a pivot pin above the tabletop. In various such embodiments, the first ejection bracket and the second ejection bracket are pivotally connected along a pivot axis above the tabletop.

It will be understood that modifications and variations may be affected without departing from the scope of the novel concepts of the present invention, and it is understood that this application is to be limited only by the scope of the claims.

1. A truss assembly table comprising:
a table frame;
a tabletop connected to the table frame; and
a plurality of spaced-apart ejection mechanisms supported by at least one of the table frame and the tabletop, each ejection member including:
a first ejection bracket,
a second ejection bracket,
a first truss ejector connected to the first ejection bracket,
a second truss ejector connected to the second ejection bracket,
a hinge assembly pivotally connecting the first and second ejection brackets, and
an actuator connected to the first and second ejection brackets, the actuator configured to simultaneously move the first and second ejection brackets from lower positions to upper positions to simultaneously move the first and second truss ejectors from retracted positions to extended positions.

2. The truss assembly table of claim 1, wherein then first truss ejector includes a driven first rotatable roller supported at opposite ends by roller supports connected to and extending upwardly from the first ejection bracket, and the second truss ejector includes a driven second rotatable roller supported at opposite ends by roller supports connected to and extending upwardly from the second ejection bracket.

3. The truss assembly table of claim 1, wherein the first ejection bracket has an upper section and a lower section, wherein the lower section is narrower than the upper section, and wherein the second ejection bracket has an upper section and a lower section, wherein the lower section is narrower than the upper section.

4. The truss assembly table of claim 3, wherein the actuator is pivotally connected to the lower section of the first ejection bracket and pivotally connected to the lower section of the second ejection bracket.

5. The truss assembly table of claim 4, wherein the actuator extends between the lower section of the first ejection bracket and the lower section of the second ejection bracket.

6. The truss assembly table of claim 1, wherein the hinge assembly pivotally connects the upper section of the first ejection bracket to the upper section of the second ejection bracket.

7. The truss assembly table of claim 1, wherein the hinge assembly is mounted on the tabletop.

8. The truss assembly table of claim 1, wherein the hinge assembly includes a pivot pin above the tabletop.

9. The truss assembly table of claim 1, wherein the first ejection bracket and the second ejection bracket are pivotally connected along a pivot axis above the tabletop.

10. A truss assembly table ejection mechanism for a truss assembly table including a table frame and a tabletop connected to the table frame, the truss assembly table ejection mechanisms comprising:
a first ejection bracket;
a second ejection bracket;
a first truss ejector connected to the first ejection bracket;
a second truss ejector connected to the second ejection bracket;
a hinge assembly pivotally connecting the first and second ejection brackets; and
an actuator connected to the first and second ejection brackets, the actuator configured to simultaneously move the first and second ejection brackets from lower positions to upper positions to simultaneously move the first and second truss ejectors from retracted positions to extended positions.

11. The truss assembly table ejection mechanism of claim 10 wherein then first truss ejector includes a driven first rotatable roller supported at opposite ends by roller supports connected to and extending upwardly from the first ejection bracket, and the second truss ejector includes a driven second rotatable roller supported at opposite ends by roller supports connected to and extending upwardly from the second ejection bracket.

12. The truss assembly table ejection mechanism of claim 10, wherein the first ejection bracket has an upper section and a lower section, wherein the lower section is narrower than the upper section, and wherein the second ejection bracket has an upper section and a lower section, wherein the lower section is narrower than the upper section.

13. The truss assembly table ejection mechanism of claim 12, wherein the actuator is pivotally connected to the lower section of the first ejection bracket and pivotally connected to the lower section of the second ejection bracket.

14. The truss assembly table ejection mechanism of claim 13, wherein the actuator extends between the lower section of the first ejection bracket and the lower section of the second ejection bracket.

15. The truss assembly table ejection mechanism of claim 10, wherein the hinge assembly pivotally connects the upper section of the first ejection bracket to the upper section of the second ejection bracket.

16. The truss assembly table ejection mechanism of claim 10, wherein the hinge assembly is mountable on the tabletop.

17. The truss assembly table ejection mechanism of claim 10, wherein the hinge assembly includes a pivot pin configured to be positioned above the tabletop.

18. The truss assembly table ejection mechanism of claim 10, wherein the first ejection bracket and the second ejection bracket are configured to be pivotally connected along a pivot axis above the tabletop.
